(19) United States
(12) Patent Application Publication
(10) Pub. No.: US 2019/0299298 A1
(43) Pub. Date: Oct. 3, 2019

(54) Clamping Device For Securing A Clamping Part

(71) Applicant: Neumayer Tekfor Engineering GmbH, Hausach (DE)

(72) Inventors: Niels VOGEL, Sontra (DE); Daniel ASCHENBRENNER, Alheim (DE); Andreas PENNER, Bad Hersfeld (DE); Steffen TRINTER, Ronshausen (DE)

(21) Appl. No.: 16/367,845

(22) Filed: Mar. 28, 2019

(30) Foreign Application Priority Data
Mar. 29, 2018 (DE) 10 2018 002 624.9

(51) Int. Cl. B23B 31/20; B23Q 3/06; B25B 1/06

(52) U.S. Cl. CPC B23B 31/201; B23B 31/208; B23B 2231/2072; B25B 1/06; B23B 2231/14; B23Q 3/067

(57) ABSTRACT

A clamping device for the securing of a clamping part is provided. The clamping device includes a stop element and a radial clamping device which define an inner space to partly hold the clamping part. The radial clamping device in a clamped condition exerts a radial securing force on the clamping part. A radial spacing exists between the radial clamping device and a clamping bush radially enclosing the clamping device. The clamping bush and the radial clamping device are radially movable relative to one another, such that the radial clamping device is mounted floating in the clamping bush.

### CROSS REFERENCE TO RELATED APPLICATION

This application claims priority under 35 U.S.C. § 119 from German Patent Application No. 10 2018 002 624.9, filed Mar. 29, 2018, the entire disclosure of which is herein expressly incorporated by reference.

### BACKGROUND AND SUMMARY OF THE INVENTION

The present invention relates to a clamping device for the securing of a clamping part. The clamping part for example is a workpiece which is to be machined while it is held by the clamping device.

For the machining and especially the chip removing machining of workpieces (e.g., those made of metal) it is known in the prior art how to generate a relative movement between the workpiece and a tool. The movement usually consists in rotating one of the components (i.e., the workpiece or the tool) about an axis of rotation. For generating the rotation, a corresponding rotation device is present, which is mechanically coupled to a mating clamping device, which in turn holds the component in question firmly.

For example, if a workpiece having an end toothing is being clamped, such as a plan-notch or a Hirth toothing, there may occur a center offset between a pressing contour and the end toothing. For this problem, it is known how to use angle pin chucks. However, these are very costly to manufacture. Furthermore, standardized collet chucks cannot be used and moreover only slight center offsets can be bridged by angle pins. Alternatively, jaw chucks with floating clamping jaws can be used. The drawback here is that jaw chucks have no axial tension effect. The centering of the end toothing is not assured. Finally, at high speeds of rotation the clamping jaws widen, so that the clamping force is reduced.

DE 10 2006 048 447 A1 discloses a clamping device serving for the mounting of a test specimen. The test specimen is received radially by a collet chuck and rests by its end face against a stop mandrel. The collet chuck itself is held by a centering ring and is mounted floating in a base body. No details about the floating mount are mentioned in the document.

The problem which the invention proposes to solve is to propose a clamping device for the securing of a clamping part, which ensures an equalizing of a center offset especially in the case when the clamping part has an end toothing, and which avoids the drawbacks of the prior art.

The invention solves the problem by a clamping device for the securing of a clamping part, wherein the clamping device is connectable to a rotation device, wherein the clamping device comprises a stop element, wherein the stop element and a radial clamping device form an inner space to partly hold the clamping part, wherein the radial clamping device in a clamped condition exerts a radial securing force on the clamping part, wherein the radial clamping device is enclosed radially by a clamping bush, and wherein a radial spacing exists between the clamping bush and the radial clamping device, and the clamping bush and the radial clamping device are radially movable with respect to one another, such that the radial clamping device is mounted floating in the clamping bush.

The clamping device exerts on the clamping part in the clamped condition (i.e., when the clamping device is holding the clamping part) a radial force. This occurs by way of the radial clamping device. The radial clamping device is provided with a radial spacing owing to the clamping bush which encloses it. Furthermore, the clamping bush and the radial clamping device are radially movable with respect to one another. The two aforementioned attributes have the effect that a radial displacement of the radial clamping device and thus also the clamping part is possible. The clamping part thrusts against the stop element when the part is present in the inner space and secured in the clamping device. Thus, owing to the radial spacing, a gap is produced between clamping bush and radial clamping device. The gap allows for example a balancing out of a center offset of the component with respect to the axis of rotation of the rotation device.

In one embodiment, the radial spacing—at least on average or generally—is less than 1 mm. In another embodiment, the radial spacing is between 0.25 mm and 0.75 mm. In another embodiment, the radial spacing is 0.5 mm.

One embodiment consists in that the stop element has a toothing which is a mating toothing to an end toothing of the clamping part. Such a toothing in the stop element has the effect of securing against twisting of the clamping part, since the toothings mesh with each other.

One embodiment proposes that the stop element has a mating toothing to a Hirth toothing (an alternative designation is a plan-notch toothing).

One embodiment consists in that a collet chuck and a clamping ring radially enclosing the collet chuck form the radial clamping device, and in that the collet chuck has a wedge-shaped outside and the clamping ring has a wedge-shaped inside corresponding to the wedge-shaped outside of the collet chuck.

One embodiment proposes that the clamping ring emerges at the end face on a shoulder, which is engaged by an end region of the clamping bush. Thus, the clamping ring in this embodiment is not only enclosed radially by the clamping bush, but the clamping bush also partly forms the axial or end face termination of the clamping ring. The shoulder is produced in that the clamping ring has different axial extensions for a portion. In one embodiment in particular, the shoulder is situated in the radial outside of the clamping ring.

One embodiment consists in that the clamping bush and the radial clamping device are free of any radial and/or axial securing to one another. In one embodiment, the clamping bush and the radial clamping device are merely inserted one into the other, so that in this way likewise no securing between the two of them results. The lack of a radial securing makes it possible for the radial clamping device to move radially relative to the clamping bush and thus balance out any deviations of the clamping part. This produces on the whole a floating mount of the radial clamping device. The floating mount pertains at least to the radial mobility of the radial clamping device relative to the clamping bush (i.e., perpendicular to the longitudinal axis of the clamping device). In one extension, this also pertains to the axial mobility.

One embodiment proposes that a seal element is present, which closes off an end-face access to the radial spacing. The end-face access in one embodiment in particular pertains to the end face of the clamping device. The seal element prevents for example the intrusion of water or dust.

One embodiment consists in that the clamping bush is connected to a base body of the clamping device—preferably via a screw—and in that the base body serves for a connecting of the clamping device to the rotation device. In one embodiment, the base body and the clamping bush together form a kind of cup, in which the radial clamping device is introduced. In this case, the radial mobility of the radial clamping device is especially important.

In a further embodiment, the base body makes contact with a connection device, having a draw tube and a ball joint. The base body of the clamping device in this embodiment by way of the kind of ball joint enables a further correction in regard to axial or radial deviations between individual components. In this way, the base body is indirectly connected to the rotation device.

One embodiment proposes that the clamping bush is connected to the base body only axially parallel to a longitudinal axis of the clamping device—especially via a screw.

Another embodiment consists in that at least a medium guide duct is present, emerging into the inner space. In one embodiment, the medium guide duct is situated in the stop element and terminates, in an additional or alternative embodiment, in the region of the toothing of the stop element. The medium guide duct in one variant is used for air control, to make sure that the clamping part lies firmly against the toothing. Alternatively to the air control, the medium guide duct can be used as a conduit for media other than air. Thus, for example, in one application a cooling medium is conveyed to the clamping part. This enables a cleaning of shavings from the clamping part and the stop element in one embodiment.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 a section through a clamping device with a first clamping part in the clamped condition in accordance with an embodiment of the present invention,

FIG. 2 a cutout of the clamping device of FIG. 1 without the clamping part and

FIG. 3 a section through a clamping device with a second clamping part in accordance with an embodiment of the present invention.

### DETAILED DESCRIPTION OF THE DRAWINGS

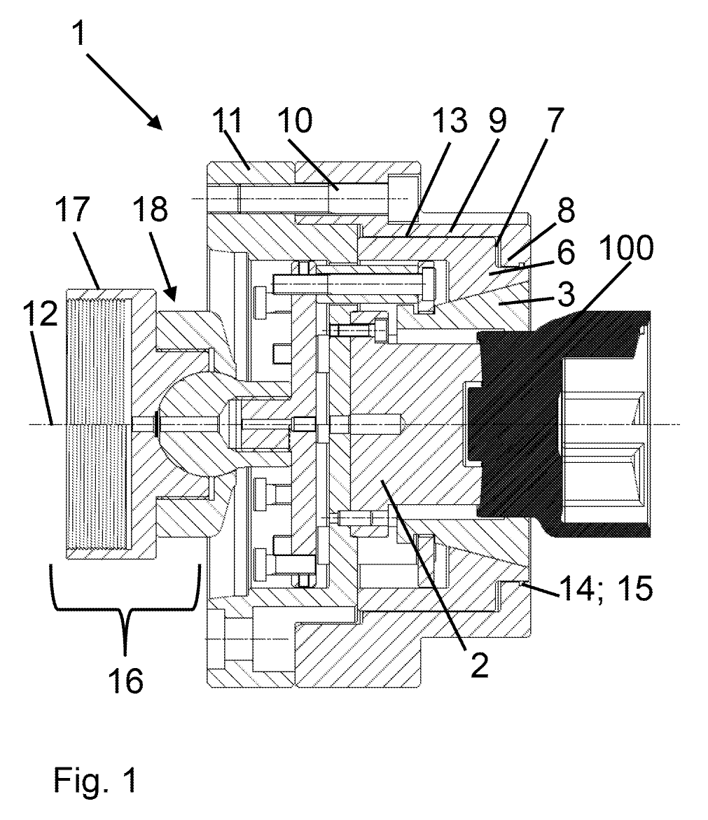

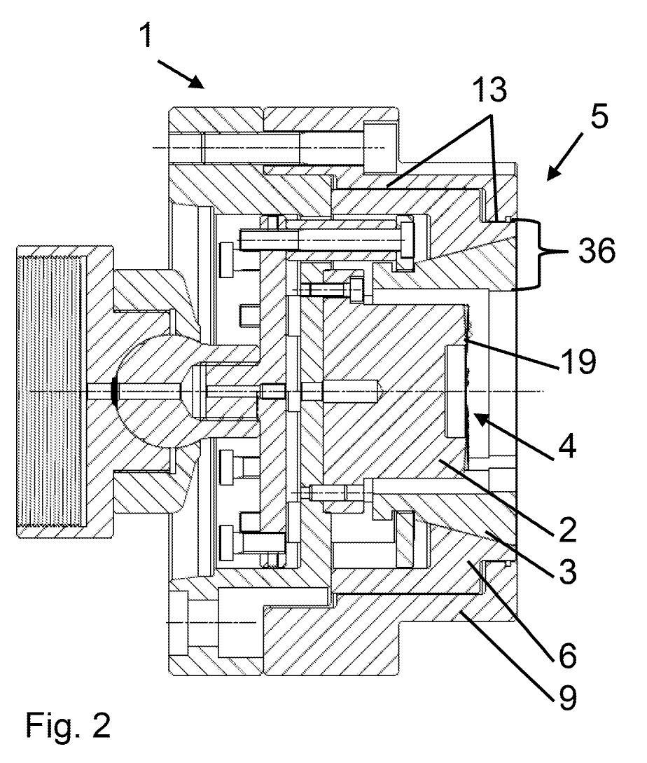

FIG. 1 shows the condition in which a first clamping part 100 is clamped in a clamping device 1. Hence, a collet chuck is also described. The corresponding FIG. 2 shows the same clamping device 1, but without the clamping part 100. Therefore, both FIGS. 1 and 2 shall be discussed together.

The clamping part 100 here is, for example, a workpiece, having a Hirth toothing and undergoing machining. For the machining, the clamping part 100 is clamped and turned about an axis by a rotation device—not shown here. The clamping here occurs in particular by way of a radial force, which is exerted on the clamping part 100 in the clamped condition and thereby holds it firmly.

The clamping device 1 has a stop element 2, against which the clamping part 100 thrusts. The stop element 2 is surrounded radially by a collet chuck 3. The stop element 2 and the collet chuck 3 are designed and arranged relative to each other in such a way that a free inner space 4 (see FIG. 2) is produced at the end face 5 of the clamping device 1. This inner space receives (as shown in FIG. 1) an end face of the clamping part 100. Further details about this will be seen in connection with FIG. 2.

The collet chuck 3 is radially surrounded by a clamping ring 6.

The collet chuck 3 has a wedge-shaped outside and the clamping ring 6 has a wedge-shaped inside. The two wedge shapes are adjusted or correspond to each other such that the best possible contact surface is produced between the two components 3, 6 and such that in the clamped state the collet chuck 3 exerts the mentioned radial force on the clamping part 100. Thus, the collet chuck 3 and the clamping ring 6 together form a radial clamping device 36 (see FIG. 2) for generating the radial securing force for the clamping part 100.

On its outside, the clamping ring 6 terminates at the end face with a shoulder 7, engaging with an end region 8 of the clamping bush 9. The clamping bush 9 therefore radially encloses the radial clamping device 36 and also in particular the outwardly situated clamping ring 6 here.

The clamping bush 9 itself is connected by a screw 10 to a base body 11 of the clamping device 1.

The longitudinal axis 12 of the clamping device 1 in the embodiment shown is also the longitudinal axis of the clamping part 100 and it is the axis about which the rotation occurs by means of the rotation device—not shown here. As can be seen, there is a slight limiting of the clamping movement in the form of a spacing in the axial direction between the clamping ring 6 and the clamping bush 9.

There is no radial securing between the clamping bush 9 and the clamping ring 6. The clamping bush 9 and the clamping ring 6 are merely inserted one into the other and not joined together. This makes possible the radial mobility for balancing out the center offset.

There is a radial spacing 13—here, for example, as an air gap—between the clamping bush 9 and the clamping ring 6. So that no contaminants can get into this gap, at the end face a seal element 14 is provided (here in the form of an O-ring) in a recess 15 (here in the clamping bush 9, for example).

The radial spacing 13 between the clamping ring 6 and the surrounding clamping bush 9 and thus between the radial clamping device 36 and the clamping bush 9 brings about the floating mount of the radial clamping device 36. The floating mount makes it possible to balance out a center offset relative to the toothing of the respective clamping part 100.

Adjacent to the base body 11 is a connection device 16, enabling a connection to the rotation device—not shown here. The connection device 16 in the embodiment shown comprises a draw tube 17 and a ball joint 18. The articulated connection enables balancing out of axial errors of the spindle.

It will be noticed in particular in FIG. 2 that the stop element 2 and the collet chuck 3 surround and form an inner space 4 in the end face 5 of the clamping device 1.

Furthermore, it can be seen that the stop element 2 comprises a toothing 19. This toothing 19 in particular is a mating toothing (or in general a corresponding toothing) to the toothing of the clamping part 100. The toothing 19 brings about a securing against twisting of the clamping part 100. Furthermore, in this way the toothing of the clamping part 100 is itself centered. The radial balancing of the radial clamping device 36 occurs by way of the spacing 13 and also by way of the lack of radial connection to the radially enclosing clamping bush 9.

The association of the toothing 19 with the respective clamping part 100 means that, depending on the nature of the toothing, each clamping part type requires its own stop element 2. Furthermore, the outer diameter of the clamping part 100 requires a different collet chuck 3 each time.

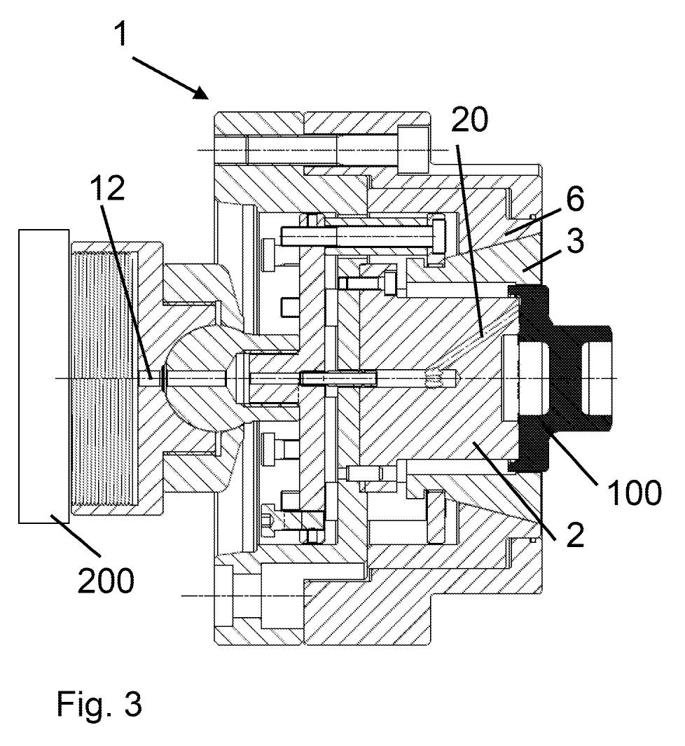

FIG. 3 shows the case of a second, alternative clamping part 100.

The clamping devices 1 of the embodiments of FIG. 1 and FIG. 3 differ from each other only in regard to the stop element 2 and the collet chuck 3. This also yields the advantage that, when switching between two different clamping parts 100, only two components of the clamping device 1 need to be changed. Since the collet chucks 3 each time have the same outer contour and especially the same wedge shape, they may be combined each time with the same clamping ring 6.

FIG. 3 furthermore indicates schematically the rotation device 200, which brings about the rotation of the clamping device 1 about the longitudinal axis 12.

Behind the end face of the stop element 2 with the toothing 19 runs a medium guide duct 20 in order to supply media, such as air for air control, to the inner space 4. Alternatively, a cooling medium can be brought up, in order to also clean the inner space 4 of shavings, for example.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A clamping device for the securing of a clamping part, comprising:
a stop element;
a radial clamping device; and
a clamping bush,
wherein
in an assembled state the stop element and the radial clamping device define an inner space configured to hold the clamping part,
the radial clamping device is configured such that in a clamped condition the radial clamping device exerts a radial securing force on the clamping part,
the radial clamping device is enclosed radially by the clamping bush,
in the assembled state a radial spacing exists between the clamping bush and the radial clamping device,
the clamping bush and the radial clamping device are radially movable with respect to one another, such that the radial clamping device is mounted floating in the clamping bush, and
the clamping device is configured to be connected to a rotation device,

2. The clamping device as claimed in claim 1, wherein
the stop element has a toothing which is a mating toothing to an end toothing of the clamping part.

3. The clamping device as claimed in claim 1,
wherein the stop element has a mating toothing to a Hirth toothing.

4. The clamping device as claimed in claim 1, wherein
the radial clamping device includes a collet chuck and a clamping ring radially enclosing the collet chuck, and
the collet chuck has a wedge-shaped outside and the clamping ring has a wedge-shaped inside corresponding to the wedge-shaped outside of the collet chuck.

5. The clamping device as claimed in claim 4, wherein
the clamping ring includes an end face formed as a shoulder configured to be engaged by an end region of the clamping bush.

6. The clamping device as claimed in claim 1, wherein
the clamping bush and the radial clamping device are not secured to one another.

7. The clamping device as claimed in claim 1, wherein
the clamping bush and the radial clamping device are inserted one into the other without radial interference.

8. The clamping device as claimed in claim 1, further comprising:
a seal element configured to close off an end-face access to the radial spacing between the clamping bush and the radial clamping device.

9. The clamping device as claimed in claim 1, wherein
the clamping bush is connected to a base body of the clamping device, and
the base body of the clamping device is configured to be connected to the rotation device.

10. The clamping device as claimed in claim 9, further comprising:
a connection device including a draw tube and a ball joint, the connection device being configured to be located between the base body and the rotation device.

11. The clamping device as claimed in claim 1, further comprising:
a guide duct configured to guide medium into the inner space.
